(19) United States
(12) Patent Application Publication
(10) Pub. No.: US 2025/0054687 A1
(43) Pub. Date: Feb. 13, 2025

(54) TRANSFORMER COMPRISING A PLURALITY OF WINDINGS

(71) Applicant: Hitachi Energy Ltd, Zürich (CH)

(72) Inventors: Rafael MURILLO JASO, Zaragoza (ES); Antonio NOGUÉS BARRIERAS, Zaragoza (ES); Carlos Manuel ROY MARTÍN, Zaragoza (ES); Lorena CEBRIÁN LLES, Zaragoza (ES); Victor Manuel GARCÍA CHOCANO, Zaragoza (ES); María Pilar MORATA ARRUE, Zaragoza (ES); Fernando MUÑOZ ARRIBAS, Zaragoza (ES)

(21) Appl. No.: 18/720,816

(22) PCT Filed: Dec. 14, 2022
(86) PCT No.: PCT/EP2022/085894

§ 371 Date: Jun. 17, 2024

(30) Foreign Application Priority Data
Dec. 17, 2021 (EP) 21383154.8

(51) Int. Cl. H01F 27/30; H01F 27/34

(52) U.S. Cl. CPC H01F 27/303; H01F 2027/348

(57) ABSTRACT

A transformer includes a plurality of windings including a first winding and a second winding, wherein the first winding includes a first winding portion and a second winding portion at a second position in the axial direction and in the radial direction, the first position different from the second position, the number of turns of the first winding portion being different from the number of turns of the second winding portion, wherein the second winding includes a third winding portion at a third position and a fourth winding portion at a fourth position in the axial direction and in the radial direction, the third position different from the fourth position in the axial direction, and the number of turns of the third winding portion being different from the number of turns of the fourth winding portion.

### CROSS REFERENCE TO RELATED APPLICATIONS

This application is a 35 U.S.C. § 371 national stage application of PCT International Application No. PCT/EP2022/085894 filed on Dec. 14, 2022, which in turn claims foreign priority to European Patent Application No. 21383154.8, filed on Dec. 17, 2021, the disclosures and content of which are incorporated by reference herein in their entirety.

### FIELD OF THE DISCLOSURE

The present disclosure relates to a transformer comprising a plurality of windings and a respective method for controlling losses of the transformer.

### BACKGROUND

In recent years, the development of apparatus for generating renewable energy has continuously attracted attention, which consequently has resulted in a steady growth of the market share and in a large distribution of home-scaled distributed energy resources, DERs, including a solar panel. In view of said trend, it has become of high importance to develop a power converter, in particular a transformer comprising a plurality of windings, so as to allow connection of multiple apparatus to a power distribution with a high power efficiency. In general, the DERs, in particular photovoltaic panels, generate relatively low voltages, LV, with respect to the operation voltage of the power distribution grid, HV.

The currently proposed possible winding configurations of multi-winding transformers, in particular configurations for a three-winding transformer are categorized based on the geometrical orientation of a plurality of LV windings and at least one HV winding. In particular, a stacked LV winding configuration winds a first LV winding around a transformer core at a first position along the transformer core, a second LV winding around the transformer core at a second position along the transformer core, a first split HV winding made by two paralleled HV circuits around the first LV winding, and the remaining split HV winding made by two paralleled HV circuits around the second LV winding. Such configuration exhibits a relatively high leakage impedance between the two LV windings, in particular a reactance arising from a leakage inductance, at the LV windings with respect to the leakage impedance at the HV winding. In other words, said configuration achieves low leakage reactance ratio, k, (e.g. K≤0.1), defined as:

$$K = \frac{{X}_{P}}{{X}_{S} + {X}_{P}} \qquad ( 1 )$$

wherein X_{P} denotes the leakage reactance from the primary side (at the HV winding) and Xₛ denotes the leakage reactance from the secondary side (at the LV winding). This configuration has been widely applied in transformer designs, but, depending on the HV winding technology, can lead to large winding heights, sometimes exceeding the maximum transformer heights acceptable for a particular application. One possible solution to reduce the transformer height is to use a non-split HV winding, instead of the split HV winding made by two paralleled HV circuits. The stacked LV configuration, in particular when the two LV windings show a significantly different load, produces a certain pattern of the leakage flux, which in turn produces a large increase of the winding eddy losses, leading to unacceptable temperature hot spots.

Alternatively, a split stacked LV winding is proposed as an extension of the stacked LV winding configuration. The split stacked LV winding further winds a second LV winding around the first LV winding of the stacked LV winding configuration and a first LV winding around the second LV winding of the stacked LV winding configuration. As a result, a high leakage reactance ratio (e.g. K≥0.1) is achieved. This configuration, due to the fact each of the two LV windings are distributed along the full height of the HV winding, avoids the large eddy losses and the formation of hot spots, in case the two LV windings show significantly different loads. However, as the achieved leakage reactance ratio is high (e.g. K≥0.1), the impedance between the two LV windings is small, thereby potentially failing to fulfill with the impedance requirements in some particular applications.

Thus, there is a need to improve a transformer comprising a plurality of windings and a respective method for controlling losses of the transformer.

### SUMMARY

The present disclosure relates to a transformer comprising a plurality of windings and a respective method for controlling losses of the transformer.

The present disclosure relates to a transformer comprising a plurality of windings, the plurality of windings comprising a first winding and a second winding, wherein the first winding comprises a first winding portion at a first position in an axial direction and in a radial direction, and a second winding portion at a second position in the axial direction and in the radial direction, wherein the first position is different from the second position in the axial direction, wherein the number of turns of the first winding portion is different from the number of turns of the second winding portion, wherein the second winding comprises a third winding portion at a third position in the axial direction and in the radial direction, and a fourth winding portion at a fourth position in the axial direction and in the radial direction, wherein the third position is different from the fourth position in the axial direction, and wherein the number of turns of the third winding portion is different from the number of turns of the fourth winding portion.

According to an embodiment, the axial direction is parallel to a tangent vector of an axis of a core of the transformer and the radial direction is parallel to a vector within an orthogonal plane having a normal vector parallel to the tangent vector.

According to an embodiment, the axial direction is parallel to a tangent vector tangential to an axis of a core of the transformer and the radial direction is parallel to a vector within an orthogonal plane having a normal vector parallel to the tangent vector.

According to an embodiment, the number of turns of the first winding portion is greater than the number of turns of the second winding portion and/or the number of turns of the third winding portion is greater than the number of turns of the fourth winding portion.

According to an embodiment, the number of turns of the first winding portion is greater, by at least 50%, than the number of turns of the second winding portion and/or the number of turns of the third winding portion is greater, by at least 50%, than the number of turns of the fourth winding portion.

According to an embodiment, the number of turns of the second winding portion is greater than the number of turns of the first winding portion and/or the number of turns of the fourth winding portion is greater than the number of turns of the third winding portion.

According to an embodiment, the number of turns of the second winding portion is greater, by at least 50%, than the number of turns of the first winding portion and/or the number of turns of the fourth winding portion is greater, by at least 50%, than the number of turns of the third winding portion.

According to an embodiment, the number of turns of the first winding portion is equal to the number of turns of the third winding and/or the number of turns of the second winding portion is equal to the number of turns of the fourth winding portion.

According to an embodiment, the ratio of the number of turns in the first winding portion to the number of turns in the second winding portion is equal to the ratio of the number of turns in the third winding portion to the number of turns in the fourth winding portion.

According to an embodiment, the first winding portion is electrically connected, in particular in series, with the second winding portion and the third winding portion is electrically connected, in particular in series, with the fourth winding portion.

According to an embodiment, the first winding portion at least partially overlaps with the second winding portion in the radial direction and/or the third winding portion at least partially overlaps with the fourth winding portion in the radial direction.

According to an embodiment, the first winding portion at least partially overlaps with the fourth winding portion in the axial direction and/or radial direction.

According to an embodiment, the fourth winding portion at least partially overlaps with the second winding portion in the radial direction.

According to an embodiment, the third winding portion at least partially overlaps with the second winding portion in the axial direction and/or in the radial direction.

According to an embodiment, the plurality of windings further comprises a third winding at a fifth position in the axial direction and in the radial direction.

According to an embodiment, the third winding at least partially overlaps with the first winding and/or the second winding in the axial direction and/or the radial direction.

The present disclosure also relates to a method for controlling losses of a transformer according to any one of the above described embodiments.

According to an embodiment, the first winding and the second winding are secondary windings and the third winding is a primary winding.

According to an embodiment, the voltage across the primary winding is relatively higher than the voltage cross at least one secondary winding.

Various exemplary embodiments of the present disclosure disclosed herein are directed to providing features that will become readily apparent by reference to the following description when taken in conjunction with the accompanying drawings. In accordance with various embodiments, exemplary systems, methods, and devices are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 illustrates a transformer according to an embodiment of the present disclosure.

FIG. 2 illustrates a cross sectional view of a transformer according to an embodiment of the present disclosure.

FIG. 3 illustrates a cross sectional view of a transformer according to an embodiment of the present disclosure.

FIG. 4 illustrates a transformer according to an embodiment of the present disclosure.

FIG. 5 illustrates a transformer according to an embodiment of the present disclosure.

FIG. 6 illustrates a cross sectional view of a transformer according to an embodiment of the present disclosure.

In the following, exemplary embodiments of the disclosure will be described. It is noted that some aspects of any one of the described embodiments may also be found in some other embodiments unless otherwise stated or obvious. However, for increased intelligibility, each aspect will only be described in detail when first mentioned and any repeated description of the same aspect will be omitted.

### DETAILED DISCLOSURE

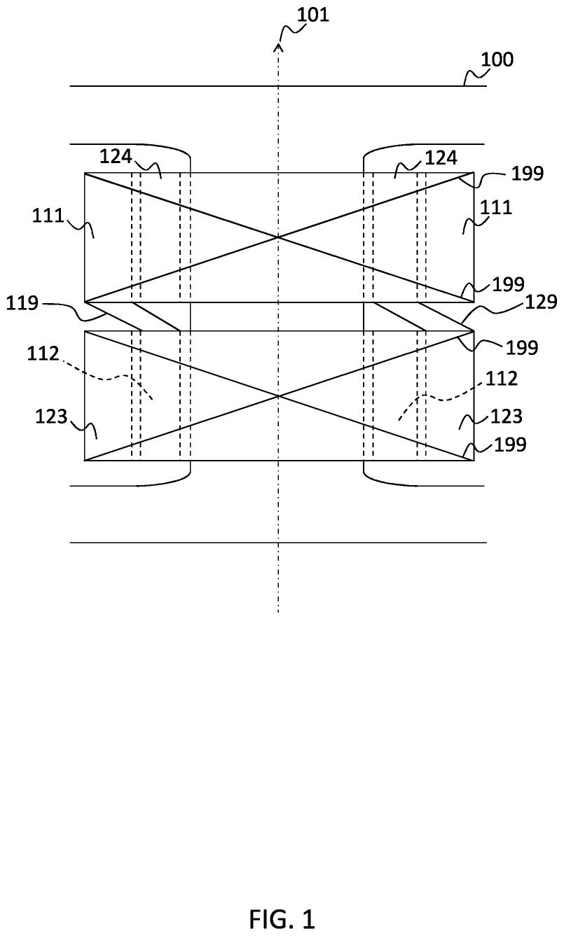

FIG. 1 illustrates a transformer according to an embodiment of the present disclosure. In particular, FIG. 1 illustrates a cross sectional view of a transformer 100 wound with a plurality of windings comprising a first winding and a second winding. The illustrated cross-sectional view is a planar view of a plane through said transformer 100, wherein said plane comprises a vector in an axial direction 101 of the transformer 100. It is understood by the skilled person that said plane may alternatively comprise a vector parallel to the vector in the axial direction 101 of the transformer, in particular having a centroid as a point of reference. It is further understood by the skilled person that said plane may comprise any other predetermined vector. The axial direction is the direction perpendicular to the plane of a predetermined structure, in particular a cube, more particularly a cuboid. Said plurality of windings are wound around the transformer 100, in particular around the cuboid of the transformer defining the axial direction, more particularly in a radial direction. It is understood by the skilled person in the art that the wording ‘wound’ is used, without limitation particularly on the resulting shape of the windings, to describe a general process of forming a desired geometrical sizes, shapes, or the like of the windings, particularly around a point, an axis, or the like. The radial direction is defined as the direction described by a vector in the plane perpendicular to the vector in the axial direction 101. It is understood by the skilled person that the wording ‘radial direction’ is used, without limitation particularly on the shape of the windings, to be coherent with above described wording ‘wound’. In other words, winding in a radial direction may be winding in a circular form or may be winding in any other form or shape.

The first winding in said plurality of windings comprises a first winding portion 111 at a first position in the axial direction and in the radial direction, and a second winding portion 112 at a second position in the axial direction and in the radial direction. The first position in the axial direction and in the radial direction describe a point in space defined based on a vector in the axial direction and a vector in the radial direction with respect to a point of reference. Similarly, the second position in the axial direction and in the radial direction describe a point in space defined based on a vector in the axial direction and a vector in the radial direction with respect to a point of reference. The point of reference to which the first position and the second position refer may be a centroid of the cuboid of the transformer 100 around which said windings are wound. Moreover, the first position may be a point within the space occupied by the first winding portion 111 and the second position may be a point within the space occupied by the second winding portion 112. The first position is different from the second position in the axial direction. Alternatively, the first position may be a first centroid of the cuboid of the transformer 100, around which the first winding portion 111 is wound. That is, a vector in the radial direction, starting from the first position, may describe a point within the space occupied by the first winding portion 111. Similarly, the second position may be a second centroid of the cuboid of the transformer 100, around which the second winding portion 112 is wound. That is, a vector in the radial direction, starting from the second position, may describe a point within the space occupied by the second winding portion 112. The first position is different from the second position in the axial direction. Furthermore, the number of turns of the first winding portion 111 is different from the number of turns of the second winding portion 112. The first winding portion 111 is electrically connected to the second winding portion 112, in particular by means of a first wire 119.

The second winding in said plurality of windings comprises a third winding portion 123 at a third position in the axial direction and in the radial direction, and a fourth winding portion 124 at a fourth position in the axial direction and in the radial direction. The third position in the axial direction and in the radial direction describe a point in space defined based on a vector in the axial direction and a vector in the radial direction. Similarly, the fourth position in the axial direction and in the radial direction describe a point in space defined based on a vector in the axial direction and a vector in the radial direction. A reference point to which the third position and the fourth position refer may be a centroid of the cuboid of the transformer 100 around which said windings are wound. Moreover, the third position may be a point within the space occupied by the third winding portion 223 and the fourth position may be a point within the space occupied by the fourth winding portion 224. The third position is different from the fourth position in the axial direction. Alternatively, the third position may be a third centroid of the cuboid of the transformer 100, around which the third winding portion 123 is wound. That is, a vector in the radial direction, starting from the third position, may describe a point within the space occupied by the third winding portion 123. Similarly, the fourth position may be a fourth centroid of the cuboid of the transformer 100, around which the fourth winding portion 124 is wound. That is, a vector in the radial direction, starting from the fourth position, may describe a point within the space occupied by the fourth winding portion 124. According to an embodiment, the first position may be equal to the fourth position in the axial direction and/or the second position may be equal to the third position in the axial direction. The third position is different from the fourth position in the axial direction. Furthermore, according to an embodiment, the number of turns of the third winding portion 123 is different from the number of turns of the fourth winding portion 124. The third winding portion 123 is electrically connected to the fourth winding portion 124, in particular by means of a second wire 129.

In FIG. 1, the cross signs 199, or equivalently ‘X’ signs, around the first winding portion 111 and the fourth winding portion 124, and around the second winding portion 112 and the third winding portion 123 indicate that the first 111, the second 112, the third 123, and the fourth winding portions 124 are wound around the cuboid of the transformer 100.

According to an embodiment, the first winding portion is electrically connected, in particular in series, with the second winding portion and the third winding portion is electrically connected, in particular in series, with the fourth winding portion.

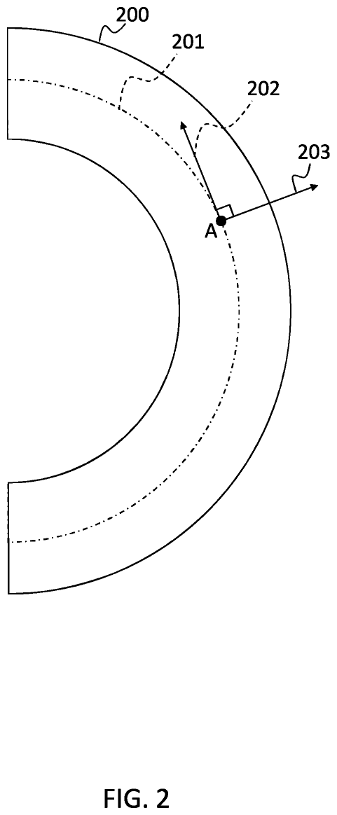

FIG. 2 illustrates a cross sectional view of a transformer core according to an embodiment of the present disclosure. In particular, a transformer core 200 is toroidally shaped and a vector in the axial direction 202 is defined as the tangential vector 202 along the centroid line 201. The tangential vector 202 along the centroid line 201 at a position A is perpendicular to the plane comprising a vector in the radial direction 203. It is understood by the person having ordinary skill in the art that any other shapes of the transformer core may be alternatively used adopting the definitions of the axial direction and the radial direction described herein.

According to an embodiment, the axial direction is parallel to a tangent vector of an axis of a core of the transformer and the radial direction is parallel to a vector within an orthogonal plane having a normal vector parallel to the tangent vector.

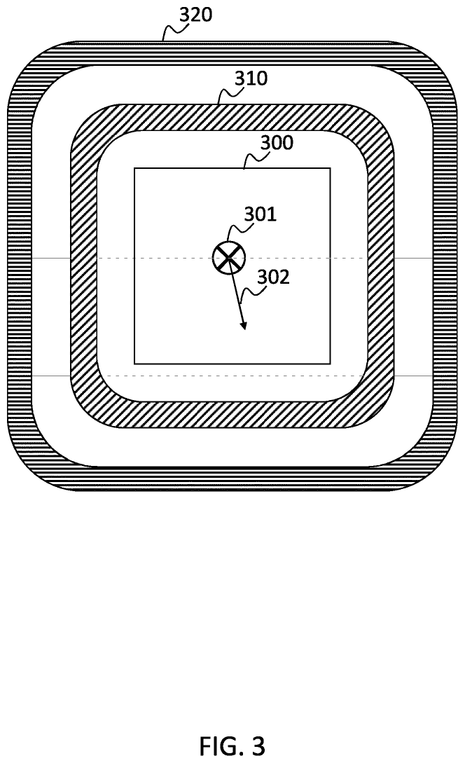

FIG. 3 illustrates a cross sectional view of a transformer according to an embodiment of the present disclosure. In particular, the cross-sectional view depicts the plane perpendicular to the vector in the axial direction 101 described in FIG. 2. That is, the vector in the axial direction 301 is the vector moving into the page and is positioned at the centroid of the cuboid of the transformer 300. A vector in the radial direction 302 is a vector in the cross-sectional plane. In reference to FIG. 2 and the descriptions thereof, when the cross-sectional plane comprises the first position and/or the third position, the cuboid of the transformer 300 is interpreted as wound around with the first winding portion 320 and the fourth winding portion 310. In the radial direction, the area covered by the first winding portion 320 fully overlaps with the area covered by the fourth winding portion 310. However, it is understood by the skilled person that the area covered by the first winding portion 320 may partially overlap with the area covered by the fourth winding portion 310. Similarly, when the cross-sectional plane comprises the second position and/or the third position, the cuboid of the transformer 300 is interpreted as wound around the third winding portion 320 and the second winding portion 310. In the radial direction, the area covered by the third winding portion 320 fully overlaps with the area covered by the second winding portion 310. However, it is understood by the skilled person that the area covered by the third winding portion 320 may partially overlap with the area covered by the second winding portion 310.

According to an embodiment, the first winding portion at least partially overlaps with the second winding portion in the radial direction and/or the third winding portion at least partially overlaps with the fourth winding portion in the radial direction.

According to an embodiment, the first winding portion at least partially overlaps with the fourth winding portion in the axial direction and/or radial direction.

According to an embodiment, the fourth winding portion at least partially overlaps with the second winding portion in the radial direction.

According to an embodiment, the third winding portion at least partially overlaps with the second winding portion in the axial direction and/or in the radial direction.

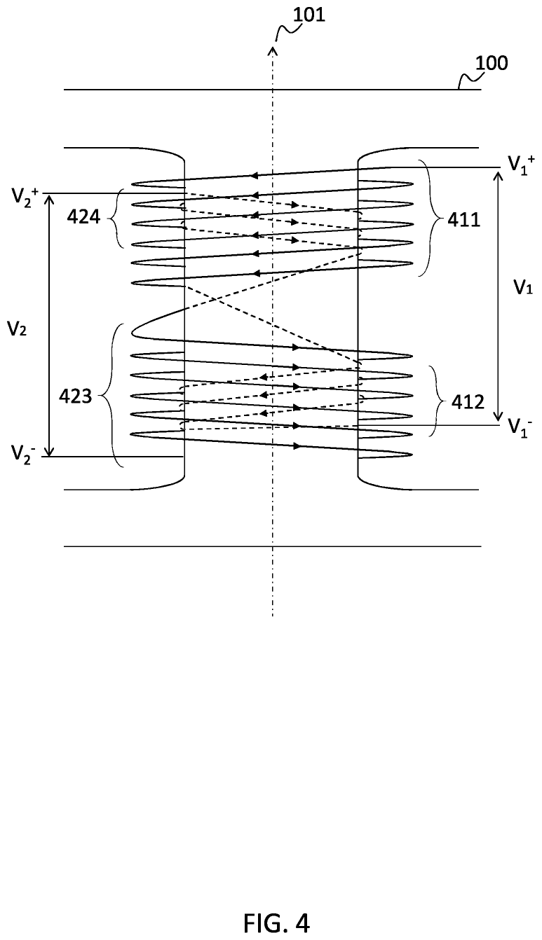

FIG. 4 illustrates a transformer according to an embodiment of the present disclosure. In particular, FIG. 4 illustrates the transformer 100 and the axial axis 101 depicted in FIG. 2, and shows an exemplary first winding and the second winding. The spatial definitions of the first winding and the second winding follow FIG. 2 as well as the description thereof, thus are omitted here for simplicity.

The first winding comprises the first winding portion 411 and the second winding portion 412. The first winding portion 411 is electrically connected to the second winding portion 412. Moreover, the number of turns of the first winding portion 411 is different from the number of turns of the second winding portion 412. In particular, the number of turns of the first winding portion 411 is greater than the number of turns of the second winding portion 412. Then, the first winding portion 411 is connected to the port having an electrical potential of V₁_{⁺} and the second winding portion 412 is connected to the port having an electrical potential of V₁_{^{−}}. Thus, a first voltage V₁, equal to the potential difference between V₁_{⁺} and V₁_{^{−}}, is applied to the first winding. Alternatively, the first winding portion 411 may be connected to the port having an electrical potential of V₁_{^{−}} and the second winding portion 412 may be connected to the port having an electrical potential of V₁_{⁺}. Thus, a first voltage V₁, equal to the potential difference between V₁_{⁺} and V₁_{^{−}}, is applied to the first winding.

The second winding comprises the third winding portion 423 and the fourth winding portion 424. The third winding portion 423 is electrically connected to the fourth winding portion 424. Moreover, the number of turns of the third winding portion 423 is different from the number of turns of the fourth winding portion 424. In particular, the number of turns of the third winding portion 423 is greater than the number of turns of the fourth winding portion 424. Then, the third winding portion 423 is connected to the port having an electrical potential of V₂_{⁺} and the fourth winding portion 424 is connected to the port having an electrical potential of V₁_{^{−}}. Thus, a second voltage V₂, equal to the potential difference between V₂_{⁺} and V₂_{^{−}}, is applied to the second winding. Alternatively, the third winding portion 423 may be connected to the port having an electrical potential of V₂_{^{−}} and the fourth winding portion 424 may be connected to the port having an electrical potential of V₂_{⁺}. Thus, a second voltage V₂, equal to the potential difference between V₂_{⁺} and V₂_{^{−}}, is applied to the second winding.

According to an embodiment, the number of turns of the first winding portion is greater than the number of turns of the second winding portion and/or the number of turns of the third winding portion is greater than the number of turns of the fourth winding portion.

According to an embodiment, the number of turns of the first winding portion is greater, by at least 50%, than the number of turns of the second winding portion and/or the number of turns of the third winding portion is greater, by at least 50%, than the number of turns of the fourth winding portion.

According to an embodiment, the number of turns of the second winding portion is greater than the number of turns of the first winding portion and/or the number of turns of the fourth winding portion is greater than the number of turns of the third winding portion.

According to an embodiment, the number of turns of the second winding portion is greater, by at least 50%, than the number of turns of the first winding portion and/or the number of turns of the fourth winding portion is greater, by at least 50%, than the number of turns of the third winding portion.

According to an embodiment, the number of turns of the first winding portion is equal to the number of turns of the third winding and/or the number of turns of the second winding portion is equal to the number of turns of the fourth winding portion.

According to an embodiment, the ratio of the number of turns in the first winding portion to the number of turns in the second winding portion is equal to the ratio of the number of turns in the third winding portion to the number of turns in the fourth winding portion.

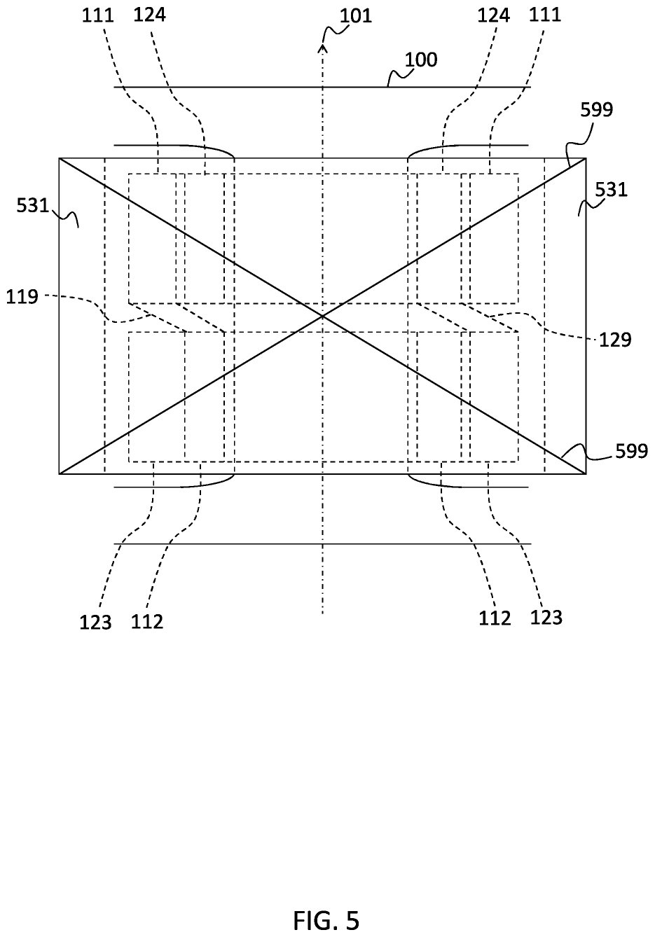

FIG. 5 illustrates a transformer according to an embodiment of the present disclosure. In particular, FIG. 5 illustrates a cross sectional view of a transformer 100 wound with a plurality of windings comprising a first winding and a second winding, as presented in FIG. 1 and the corresponding description thereof. Thus, the description of the components disclosed in FIG. 1 are omitted here for simplicity. The device in FIG. 5, in particular the plurality of windings further comprises a third winding 531 at a fifth position in the axial direction and in the radial direction. The fifth position in the axial direction and in the radial direction describe a point in space defined based on a vector in the axial direction and a vector in the radial direction. A reference point to which the fifth position refer may be a centroid of the cuboid of the transformer 100. Moreover, the fifth position may be a point within the space occupied by the third winding 531. The fifth position may be equal to or different from the first, the second, the third, and the fourth position in the axial direction.

In FIG. 5, the cross signs 599, or equivalently ‘X’ sign, around the first winding portion 111, the second winding portion 112, the third winding portion 123, the fourth winding portion 124, and the fifth winding 531 indicates that the first 111, the second 112, the third 123, the fourth winding portions 124, and the third winding 531 are wound around the cuboid of the transformer 100.

According to an embodiment, the plurality of windings further comprises a third winding at a fifth position in the axial direction and in the radial direction.

According to an embodiment, the third winding at least partially overlaps with the first winding and/or the second winding in the axial direction and/or the radial direction.

According to an embodiment, the first winding and the second winding are secondary windings and the third winding is a primary winding.

According to an embodiment, the voltage across the primary winding is relatively higher than the voltage cross at least one secondary winding.

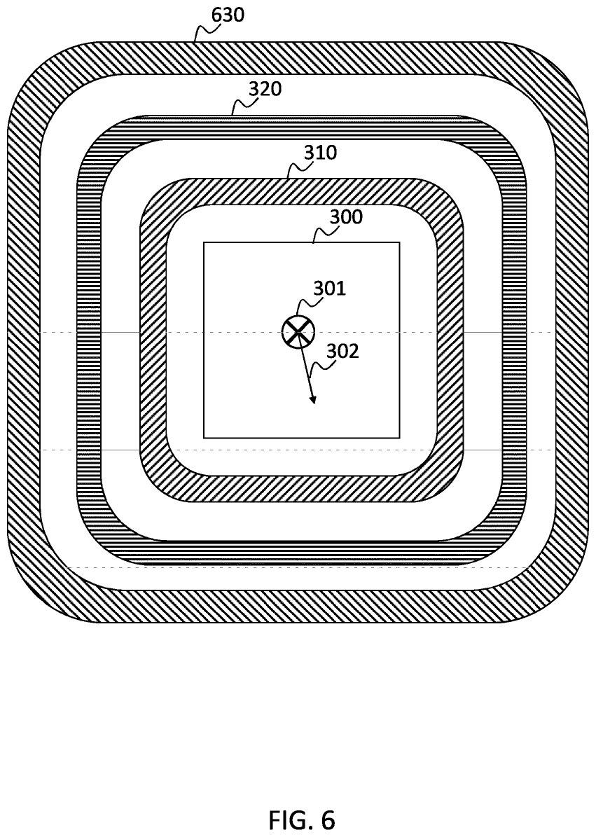

FIG. 6 illustrates a cross sectional view of a transformer according to an embodiment of the present disclosure. In particular, the cross-sectional view depicts the plane orthogonal to the vector in the axial direction 101 described in FIG. 5. That is, the axial axis 301 is a vector moving into the page and is positioned at the centroid of the cuboid of the transformer 300. A vector in the radial direction 302 is a vector in the cross-sectional plane. In reference to FIG. 5 and the descriptions thereof, when the cross-sectional plane comprises the first position and/or the third position, the cuboid of the transformer 300 is interpreted as wound around with the first winding portion 320 and the fourth winding portion 310. In the radial direction, the area covered by the first winding portion 320 fully overlaps with the area covered by the fourth winding portion 310. However, it is understood by the skilled person that the area covered by the first winding portion 320 may partially overlap with the area covered by the fourth winding portion 310. Similarly, when the cross-sectional plane comprises the second position and/or the third position, the cuboid of the transformer 300 is interpreted as wound around the third winding portion 320 and the second winding portion 310. In the radial direction, the area covered by the third winding portion 320 fully overlaps with the area covered by the second winding portion 310. However, it is understood by the skilled person that the area covered by the third winding portion 320 may partially overlap with the area covered by the second winding portion 310. The power converter in FIG. 6 further comprises a third winding 630. In the radial direction, the area covered by the third winding 630 fully overlaps with the area covered by the first winding portion 320 and/or the third winding portion 320 and the second winding portion 310 and/or the fourth winding portion 310. However, it is understood by the skilled person that the area covered by the third winding 630 may partially overlap with the area covered by the first winding portion 320 and/or the third winding portion 320 and the second winding portion 310 and/or the fourth winding portion 310.

In a particular embodiment, a transformation (e.g., 100 shown in FIG. 1 or 5) comprises a plurality of windings, wherein the plurality of windings comprises a first winding, a second winding, and a third winding.

In the particular embodiment, the first winding and the second winding may be secondary windings (e.g., high voltage winding). In addition, the third winding may be a primary winding (e.g., low voltage winding). As an alternative, the first winding and the second winding may be primary windings (e.g., low voltage winding). The third winding may be a secondary winding (e.g., high voltage winding).

In an aspect of the particular embodiment, the first winding comprises a first winding portion (e.g., 111 shown in FIG. 1 or 5) at a first position in an axial direction and in a radial direction, and a second winding portion (e.g., 112 FIG. 1 or 5) at a second position in the axial direction and in the radial direction. In this embodiment, the first winding portion may be electrically connected/coupled in series with the second winding portion. In addition, the first position may be different from the second position in the axial direction. In an aspect of the particular embodiment, the number of turns of the first winding portion is different from the number of turns of the second winding portion.

In an aspect of the particular embodiment, the second winding comprises a third winding portion (e.g., 123 shown in FIG. 1 or 5) at a third position in the axial direction and in the radial direction, and a fourth winding portion (e.g., 124 shown in FIG. 1 or 5) at a fourth position in the axial direction and in the radial direction. In this embodiment, the third winding portion may be electrically connected/coupled in series with the fourth winding portion. In addition, the third position may be different from the fourth position in the axial direction.

In an aspect of the particular embodiment, the number of turns of the third winding portion is different from the number of turns of the fourth winding portion.

In an aspect of the particular embodiment, the first winding portion at least partially overlaps with the fourth winding portion in the axial direction.

In an aspect of the particular embodiment, the third winding portion at least partially overlaps with the second winding portion in the axial direction.

In an aspect of the particular embodiment, in the radial direction, the area covered by the first winding portion at least partially overlaps with the area covered by the fourth winding portion,

In an aspect of the particular embodiment, in the radial direction, the area covered by the third winding portion at least partially overlaps with the area covered by the second winding portion,

In an aspect of the particular embodiment, the third winding (e.g., 531 shown in FIG. 5) at least partially overlaps with the first winding and the second winding in the axial direction.

In an aspect of the particular embodiment, in the radial direction, the area covered by the third winding (e.g., 531 shown in FIG. 5) at least partially overlaps with the first winding and the second winding.

In an aspect of the particular embodiment, the first winding portion is radially wound around a core of the transformer and the fourth winding portion is radially wound around the first winding portion.

In an aspect of the particular embodiment, the third winding portion is radially wound around the core of the transformer and the second winding portion is radially wound around the third winding portion

In an aspect of the particular embodiment, the third winding is radially wound around the first winding portion, the second winding portion, the third winding portion, and the fourth winding portion.

In an aspect of the particular embodiment, the number of turns of the first winding portion is greater than the number of turns of the second winding portion and/or the number of turns of the third winding portion is greater than the number of turns of the fourth winding portion.

In an aspect of the particular embodiment, the number of turns of the second winding portion is greater than the number of turns of the first winding portion and/or the number of turns of the fourth winding portion is greater than the number of turns of the third winding portion.

In an aspect of the particular embodiment, the axial direction is parallel to a tangent vector of/tangential to an axis of a core of the transformer and the radial direction is parallel to a vector within an orthogonal plane having a normal vector parallel to the tangent vector.

In an aspect of the particular embodiment, the number of turns of the first winding portion is greater than the number of turns of the second winding portion and/or the number of turns of the third winding portion is greater than the number of turns of the fourth winding portion.

In an aspect of the particular embodiment, the number of turns of the first winding portion is greater, by at least 50%, than the number of turns of the second winding portion and/or the number of turns of the third winding portion is greater, by at least 50%, than the number of turns of the fourth winding portion.

In an aspect of the particular embodiment, the number of turns of the second winding portion is greater than the number of turns of the first winding portion and/or the number of turns of the fourth winding portion is greater than the number of turns of the third winding portion.

In an aspect of the particular embodiment, the number of turns of the second winding portion is greater, by at least 50%, than the number of turns of the first winding portion and/or the number of turns of the fourth winding portion is greater, by at least 50%, than the number of turns of the third winding portion.

In an aspect of the particular embodiment, the number of turns of the first winding portion is equal to the number of turns of the third winding and/or the number of turns of the second winding portion is equal to the number of turns of the fourth winding portion.

In an aspect of the particular embodiment, the ratio of the number of turns in the first winding portion to the number of turns in the second winding portion is equal to the ratio of the number of turns in the third winding portion to the number of turns in the fourth winding portion.

In an aspect of the particular embodiment, the first winding portion is electrically connected, in particular in series, with the second winding portion and the third winding portion is electrically connected, in particular in series, with the fourth winding portion.

In an aspect of the particular embodiment, the first winding portion at least partially overlaps with the second winding portion in the radial direction and/or the third winding portion at least partially overlaps with the fourth winding portion in the radial direction.

In an aspect of the particular embodiment, the first winding portion at least partially overlaps with the fourth winding portion in the axial direction and/or radial direction.

In an aspect of the particular embodiment, the fourth winding portion at least partially overlaps with the second winding portion in the radial direction.

In an aspect of the particular embodiment, the third winding portion at least partially overlaps with the second winding portion in the axial direction and/or in the radial direction.

In an aspect of the particular embodiment, the plurality of windings further comprises a third winding at a fifth position in the axial direction and in the radial direction.

In an aspect of the particular embodiment, the third winding at least partially overlaps with the first winding and/or the second winding in the axial direction and/or the radial direction.

The present disclosure also relates to a method for controlling losses of a transformer according to any one of the above described particular embodiment and its aspects.

In an aspect of the particular embodiment, the first winding and the second winding are secondary windings and the third winding is a primary winding.

In an aspect of the particular embodiment, the voltage across the primary winding is relatively higher than the voltage cross at least one secondary winding.

The following aspects refer to particular embodiments of the present disclosure:

1. A transformer comprising a plurality of windings, the plurality of windings comprising
a first winding, a second winding, and a third winding,
wherein the first winding and the second winding are secondary windings (e.g., high voltage windings),
wherein the third winding is a primary winding (e.g., low voltage winding),
wherein the first winding comprises a first winding portion at a first position in an axial direction and in a radial direction, and a second winding portion at a second position in the axial direction and in the radial direction,
wherein the first winding portion is electrically connected in series with the second winding portion,
wherein the first position is different from the second position in the axial direction,
wherein the number of turns of the first winding portion is different from the number of turns of the second winding portion,
wherein the second winding comprises a third winding portion at a third position in the axial direction and in the radial direction, and a fourth winding portion at a fourth position in the axial direction and in the radial direction,
wherein the third winding portion is electrically connected in series with the fourth winding portion,
wherein the third position is different from the fourth position in the axial direction,
wherein the number of turns of the third winding portion is different from the number of turns of the fourth winding portion,
wherein the first winding portion at least partially overlaps with the fourth winding portion in the axial direction,
wherein the third winding portion at least partially overlaps with the second winding portion in the axial direction,
wherein, in the radial direction, the area covered by the first winding portion at least partially overlaps with the area covered by the fourth winding portion,
wherein, in the radial direction, the area covered by the third winding portion at least partially overlaps with the area covered by the second winding portion,
wherein the third winding at least partially overlaps with the first winding and the second winding in the axial direction, and
wherein, in the radial direction, the area covered by the third winding at least partially overlaps with the first winding and the second winding.

2. A transformer comprising a plurality of windings, the plurality of windings comprising
a first winding, a second winding, and a third winding,
wherein the first winding and the second winding are secondary windings (e.g., high voltage windings),
wherein the third winding is a primary winding (e.g., low voltage winding),
wherein the first winding comprises a first winding portion at a first position in an axial direction and in a radial direction, and a second winding portion at a second position in the axial direction and in the radial direction,
wherein the first winding portion is electrically connected in series with the second winding portion,
wherein the first position is different from the second position in the axial direction,
wherein the number of turns of the first winding portion is different from the number of turns of the second winding portion,
wherein the second winding comprises a third winding portion at a third position in the axial direction and in the radial direction, and a fourth winding portion at a fourth position in the axial direction and in the radial direction,
wherein the third winding portion is electrically connected in series with the fourth winding portion,
wherein the third position is different from the fourth position in the axial direction,
wherein the number of turns of the third winding portion is different from the number of turns of the fourth winding portion,
wherein the first winding portion is radially wound around a core of the transformer and the fourth winding portion is radially wound around the first winding portion,
wherein the third winding portion is radially wound around the core of the transformer and the second winding portion is radially wound around the third winding portion, and
wherein the third winding is radially wound around the first winding portion, second winding portion, third winding portion, and the fourth winding portion.

3. A transformer comprising a plurality of windings, the plurality of windings comprising
a first winding, a second winding, and a third winding,
wherein the first winding and the second winding are primary windings (e.g., low voltage windings),
wherein the third winding is a secondary winding (e.g., high voltage winding),
wherein the first winding comprises a first winding portion at a first position in an axial direction and in a radial direction, and a second winding portion at a second position in the axial direction and in the radial direction,
wherein the first winding portion is electrically connected in series with the second winding portion,
wherein the first position is different from the second position in the axial direction,
wherein the number of turns of the first winding portion is different from the number of turns of the second winding portion,
wherein the second winding comprises a third winding portion at a third position in the axial direction and in the radial direction, and a fourth winding portion at a fourth position in the axial direction and in the radial direction,
wherein the third winding portion is electrically connected in series with the fourth winding portion,
wherein the third position is different from the fourth position in the axial direction,
wherein the number of turns of the third winding portion is different from the number of turns of the fourth winding portion,
wherein the first winding portion at least partially overlaps with the fourth winding portion in the axial direction,
wherein the third winding portion at least partially overlaps with the second winding portion in the axial direction,
wherein, in the radial direction, the area covered by the first winding portion at least partially overlaps with the area covered by the fourth winding portion,
wherein, in the radial direction, the area covered by the third winding portion at least partially overlaps with the area covered by the second winding portion,
wherein the third winding at least partially overlaps with the first winding and the second winding in the axial direction, and
wherein, in the radial direction, the area covered by the third winding at least partially overlaps with the first winding and the second winding.

4. A transformer comprising a plurality of windings, the plurality of windings comprising
a first winding, a second winding, and a third winding,
wherein the first winding and the second winding are primary windings (e.g., low voltage windings),
wherein the third winding is a secondary winding (e.g., high voltage winding),
wherein the first winding comprises a first winding portion at a first position in an axial direction and in a radial direction, and a second winding portion at a second position in the axial direction and in the radial direction,
wherein the first winding portion is electrically connected in series with the second winding portion,
wherein the first position is different from the second position in the axial direction,
wherein the number of turns of the first winding portion is different from the number of turns of the second winding portion,
wherein the second winding comprises a third winding portion at a third position in the axial direction and in the radial direction, and a fourth winding portion at a fourth position in the axial direction and in the radial direction,
wherein the third winding portion is electrically connected in series with the fourth winding portion,
wherein the third position is different from the fourth position in the axial direction,
wherein the number of turns of the third winding portion is different from the number of turns of the fourth winding portion,
wherein the first winding portion is radially wound around a core of the transformer and the fourth winding portion is radially wound around the first winding portion,
wherein the third winding portion is radially wound around the core of the transformer and the second winding portion is radially wound around the third winding portion, and
wherein the third winding is radially wound around the first winding portion, second winding portion, third winding portion, and the fourth winding portion.

5. The transformer of any of aspects 1 to 4, wherein the axial direction is parallel to a tangent vector of/tangential to an axis of a core of the transformer and the radial direction is parallel to a vector within an orthogonal plane having a normal vector parallel to the tangent vector.

6. The transformer of any of aspects 1 to 5, wherein the number of turns of the first winding portion is greater than the number of turns of the second winding portion and/or the number of turns of the third winding portion is greater than the number of turns of the fourth winding portion.

7. The transformer of aspect 6, wherein the number of turns of the first winding portion is greater, by at least 50%, than the number of turns of the second winding portion and/or the number of turns of the third winding portion is greater, by at least 50%, than the number of turns of the fourth winding portion.

8. The transformer of aspect 5 or 6, wherein the number of turns of the second winding portion is greater than the number of turns of the first winding portion and/or the number of turns of the fourth winding portion is greater than the number of turns of the third winding portion.

9. The transformer of aspect 8, wherein the number of turns of the second winding portion is greater, by at least 50%, than the number of turns of the first winding portion and/or the number of turns of the fourth winding portion is greater, by at least 50%, than the number of turns of the third winding portion.

10. The transformer of any one of aspects 1 to 9, wherein the number of turns of the first winding portion is equal to the number of turns of the third winding and/or the number of turns of the second winding portion is equal to the number of turns of the fourth winding portion.

11. The transformer of any one of aspects 1 to 10, wherein the ratio of the number of turns in the first winding portion to the number of turns in the second winding portion is equal to the ratio of the number of turns in the third winding portion to the number of turns in the fourth winding portion.

12. The transformer of any one of aspects 1 to 11, wherein the first winding portion is electrically connected in series with the second winding portion and the third winding portion is electrically connected in series with the fourth winding portion.

13. The transformer of any one of aspects 1 to 12, wherein the first winding portion at least partially overlaps with the second winding portion in the radial direction and/or the third winding portion at least partially overlaps with the fourth winding portion in the radial direction.

14. The transformer of any one of aspects 1 to 13, wherein the first winding portion at least partially overlaps with the fourth winding portion in the axial direction and/or radial direction.

15. The transformer of any one of aspects 1 to 14, wherein the fourth winding portion at least partially overlaps with the second winding portion in the radial direction.

16. The transformer of any one of aspects 1 to 15, wherein the third winding portion at least partially overlaps with the second winding portion in the axial direction and/or in the radial direction.

17. The transformer of any one of aspects 1 to 16, wherein the plurality of windings further comprises a third winding at a fifth position in the axial direction and in the radial direction

18. The transformer of aspect 17, wherein the third winding at least partially overlaps with the first winding and/or the second winding in the axial direction and/or the radial direction.

19. A method for controlling losses of a transformer according to any one of aspects 1 to 18.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative methods, logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1.-16. (canceled)

17. A transformer comprising a plurality of windings, the plurality of windings comprising a first winding, a second winding, and a third winding,
wherein the first winding and the second winding are secondary windings and the third winding is a primary winding, or
the first winding and the second winding are primary windings and the third winding is a secondary winding,
wherein the first winding comprises a first winding portion at a first position in an axial direction and in a radial direction, and a second winding portion at a second position in the axial direction and in the radial direction,
wherein the first winding portion is electrically connected in series with the second winding portion,
wherein the first position is different from the second position in the axial direction and the radial direction,
wherein the number of turns of the first winding portion is different from the number of turns of the second winding portion,
wherein the second winding comprises a third winding portion at a third position in the axial direction and in the radial direction, and a fourth winding portion at a fourth position in the axial direction and in the radial direction,
wherein the third winding portion is electrically connected in series with the fourth winding portion by means of a second wire,
wherein the third position is different from the fourth position in the axial direction and the radial direction, and
wherein the number of turns of the third winding portion is different from the number of turns of the fourth winding portion,
wherein the first winding portion, the second winding portion, the third winding portion, the fourth winding portion, and the third winding are coaxially wound around a core of the transformer, and
wherein the number of turns of the first winding portion is greater than the number of turns of the second winding portion and the number of turns of the third winding portion is greater than the number of turns of the fourth winding portion, or
wherein the number of turns of the second winding portion is greater than the number of turns of the first winding portion and the number of turns of the fourth winding portion is greater than the number of turns of the third winding portion.

18. The transformer of claim 17, wherein the number of turns of the first winding portion is greater, by at least 50%, than the number of turns of the second winding portion and/or the number of turns of the third winding portion is greater, by at least 50%, than the number of turns of the fourth winding portion.

19. The transformer of claim 17, wherein the number of turns of the second winding portion is greater, by at least 50%, than the number of turns of the first winding portion and/or the number of turns of the fourth winding portion is greater, by at least 50%, than the number of turns of the third winding portion.

20. The transformer of claim 17, wherein the number of turns of the first winding portion is equal to the number of turns of the third winding and/or the number of turns of the second winding portion is equal to the number of turns of the fourth winding portion.

21. The transformer of claim 17, wherein the ratio of the number of turns in the first winding portion to the number of turns in the second winding portion is equal to the ratio of the number of turns in the third winding portion to the number of turns in the fourth winding portion.

22. The transformer of claim 17, wherein the first winding portion is electrically connected in series with the second winding portion and the third winding portion is electrically connected in series with the fourth winding portion.

23. The transformer of claim 17, wherein the first winding portion at least partially overlaps with the second winding portion in the radial direction and/or the third winding portion at least partially overlaps with the fourth winding portion in the radial direction.

24. The transformer of claim 17, wherein the first winding portion at least partially overlaps with the fourth winding portion in the axial direction and/or radial direction.

25. The transformer of claim 17, wherein the fourth winding portion at least partially overlaps with the second winding portion in the radial direction.

26. The transformer of claim 17, wherein the third winding portion at least partially overlaps with the second winding portion in the axial direction and/or in the radial direction.

27. The transformer of claim 17, wherein the plurality of windings further comprises a third winding at a fifth position in the axial direction and in the radial direction.

28. The transformer of claim 27, wherein the third winding at least partially overlaps with the first winding and/or the second winding in the axial direction and/or the radial direction.

29. A transformer comprising a plurality of windings, the plurality of windings comprising a first winding, a second winding, and a third winding,
wherein the first winding and the second winding are secondary windings and the third winding is a primary winding, or
the first winding and the second winding are primary windings and the third winding is a secondary winding,
wherein the first winding comprises a first winding portion at a first position in an axial direction and in a radial direction, and a second winding portion at a second position in the axial direction and in the radial direction,
wherein the first winding portion is electrically connected in series with the second winding portion,
wherein the first position is different from the second position in the axial direction and the radial direction,
wherein the number of turns of the first winding portion is different from the number of turns of the second winding portion,
wherein the second winding comprises a third winding portion at a third position in the axial direction and in the radial direction, and a fourth winding portion at a fourth position in the axial direction and in the radial direction,
wherein the third winding portion is electrically connected in series with the fourth winding portion by means of a second wire,
wherein the third position is different from the fourth position in the axial direction and the radial direction, and
wherein the number of turns of the third winding portion is different from the number of turns of the fourth winding portion,
wherein the first winding portion is radially wound around a core of the transformer and the fourth winding portion is radially wound around the first winding portion,
wherein the third winding portion is radially wound around the core of the transformer and the second winding portion is radially wound around the third winding portion,
wherein the third winding is radially wound around the first winding portion, the second winding portion, the third winding portion, and the fourth winding portion, and
wherein the number of turns of the first winding portion is greater than the number of turns of the second winding portion and the number of turns of the third winding portion is greater than the number of turns of the fourth winding portion, or
wherein the number of turns of the second winding portion is greater than the number of turns of the first winding portion and the number of turns of the fourth winding portion is greater than the number of turns of the third winding portion.

30. The transformer of claim 29, wherein the number of turns of the first winding portion is greater, by at least 50%, than the number of turns of the second winding portion and/or the number of turns of the third winding portion is greater, by at least 50%, than the number of turns of the fourth winding portion.

31. The transformer of claim 29, wherein the number of turns of the second winding portion is greater, by at least 50%, than the number of turns of the first winding portion and/or the number of turns of the fourth winding portion is greater, by at least 50%, than the number of turns of the third winding portion.

32. The transformer of claim 29, wherein the number of turns of the first winding portion is equal to the number of turns of the third winding and/or the number of turns of the second winding portion is equal to the number of turns of the fourth winding portion.

33. The transformer of claim 29, wherein the ratio of the number of turns in the first winding portion to the number of turns in the second winding portion is equal to the ratio of the number of turns in the third winding portion to the number of turns in the fourth winding portion.

34. The transformer of claim 29, wherein the first winding portion is electrically connected in series with the second winding portion and the third winding portion is electrically connected in series with the fourth winding portion.

35. The transformer of claim 29, wherein the first winding portion at least partially overlaps with the second winding portion in the radial direction and/or the third winding portion at least partially overlaps with the fourth winding portion in the radial direction.

36. The transformer of claim 29, wherein the first winding portion at least partially overlaps with the fourth winding portion in the axial direction and/or radial direction.
